(19) United States
(12) Patent Application Publication
(10) Pub. No.: US 2024/0370048 A1
(43) Pub. Date: Nov. 7, 2024

(54) ROTATION CONTROL COMPONENT, METHOD, DEVICE AND ELECTRONIC APPARATUS

(71) Applicant: GOERTEK INC., Weifang, Shandong (CN)

(72) Inventor: Haihong ZHANG, Weifang, Shandong (CN)

(21) Appl. No.: 18/562,866

(22) PCT Filed: Nov. 30, 2021
(86) PCT No.: PCT/CN2021/134445

§ 371 Date: Nov. 21, 2023

(30) Foreign Application Priority Data
Jun. 29, 2021 (CN) 202110731960.5

(51) Int. Cl. G05G 1/015; G01D 5/14; G05G 1/10; G05G 5/05; H01F 7/02

(52) U.S. Cl. CPC G05G 1/015; G01D 5/145; G05G 1/10; G05G 5/05; H01F 7/02; G05G 2505/00

(57) ABSTRACT

The present disclosure discloses a rotation control component, method, device and an electronic apparatus, the component comprises a housing, a rotation device, a magnetic parameter detection device and a preset number of magnets, wherein a target surface of the housing is provided with a groove for accommodating the rotation device, wherein the rotation device provided in the groove at least partially protrudes from the target surface, and a rotating axis of the rotation device is parallel to the target surface, wherein the magnets are arranged at intervals in a circumference direction of the rotation device, and the magnetic parameter detection device is provided in the housing at a position corresponding to the rotation device, for detecting magnetic parameters corresponding to respective target rotating positions where the rotation device is rotated to. The present disclosure uses the magnetic parameter detection device to detect changes of the magnetic parameters of the rotation device, which can detect the rotating positions corresponding to respective magnets in the rotation device, thereby achieving a rotating detection of the rotation device. Therefore, users can control the electronic apparatus by rotating the rotation device, and add a more stable and diverse human computer interaction mode to the electronic apparatus.

The present disclosure claims a priority of a Chinese Patent application No. 202110731960.5, titled “rotation control component, method, device and electronic apparatus” filed in China Patent Office on Jun. 29, 2021, the entire contents of which are combined into the present disclosure by reference.

### TECHNICAL FIELD

The present disclosure relates to a technical field of electronic apparatus control, and in particular to a rotation control component, a rotation control method, a rotation control device and an electronic apparatus.

### DESCRIPTION OF RELATED ART

Currently, for electronic apparatuses such as wireless glasses (such as Bluetooth glasses), Augmented Reality (AR) devices, Virtual Reality (VR) devices and wireless headphones, due to volume limitations, stable and reliable human-computer interaction modes are very limited, tapping, touching, pressing buttons, and gestures, and implementable human-computer interaction actions are also very limited.

Therefore, nowadays, it is an urgent problem to be solved how to add more stable and diverse human-computer interaction modes to electronic apparatuses, for providing users with more diverse functional operations and improving user experience.

### SUMMARY

An object of the present disclosure is to provide a rotation control component, a rotation control method, a rotation control device and an electronic apparatus, to add more stable and diverse human-computer interaction modes to electronic apparatuses, for providing users with more diverse functional operations and improving user experience.

For solving the above technical problem, the present disclosure provides a rotation control component comprising: a housing, a rotation device, a magnetic parameter detection device and a preset number of magnets,
wherein a target surface of the housing is provided with a groove for accommodating the rotation device, wherein the rotation device provided in the groove at least partially protrudes from the target surface, and a rotating axis of the rotation device is parallel to the target surface, wherein the magnets are arranged at intervals in a circumference direction of the rotation device, and the magnetic parameter detection device is provided in the housing at a position corresponding to the rotation device, for detecting magnetic parameters corresponding to respective target rotating positions where the rotation device is rotated to, and wherein the target rotation positions are rotation positions of the magnets corresponding to the magnetic parameter detection device.

optionally, the preset number is greater than or equal to 3, and magnetic parameters corresponding to the two adjacent target rotation positions detected by the magnetic parameter detection device are different, and magnetic parameters corresponding to two target rotation positions adjacent to the same target rotation position are different.

Optionally, the rotation control component further comprises:
a limiting part provided in the housing, for positioning a rotation of the rotation device when the rotation device is rotated to the respective target rotating positions.

Optionally, the rotation control component further comprises: an elastic restoring assembly corresponding to the rotation device provided in the housing, wherein the rotation device can be pressed and disposed into the groove by the elastic restoring assembly.

The present disclosure also provides a rotation control method applied to the above rotation control component, comprising steps:
acquiring magnetic parameters detected by a magnetic parameter detection device in the rotation control component;
determining a control position of a rotation device in the rotation control component according to the magnetic parameters, wherein the control position comprises target rotation positions corresponding to respective magnets in the rotation control component; and
determining a control operation of the rotation device according to the control position, wherein the control operation comprises a rotation operation.

Optionally, the step of determining a control position of a rotation device in the rotation control component according to the magnetic parameters comprises:
determining a current control position according to a current magnetic parameter and magnetic parameter ranges corresponding to respective target rotating positions, wherein the current magnetic parameter is any one of the magnetic parameters, the current control position is any of the target rotation positions, and the respective magnetic parameter ranges are not overlapped.

Optionally, when the rotation control component comprises an elastic restoring assembly corresponding to the rotation device, the step of determining a control position of a rotation device in the rotation control component according to the magnetic parameters comprises:
determining the control position according to the magnetic parameters in a first preset period, wherein the control position comprises the target rotation positions and a pressing position.

Optionally, the step of determining a control operation of the rotation device according to the control position comprises:
determining the control operation according to the control position in a second preset period, wherein the control operation comprises the rotation operation, or the rotation operation and a pressing operation, and wherein the rotation operation comprises a clockwise rotation operation and/or a counter-clockwise rotation operation, and the pressing operation comprises a click operation and/or a long pressing operation.

The present disclosure also provides a rotation control device applied to the above-described rotation control component, comprising:
an acquisition module for acquiring magnetic parameters detected by a magnetic parameter detecting device in the rotation control component;
a position determination module for determining a control position of a rotation device in the rotation control component according to the magnetic parameters, wherein the control position comprises target rotation positions corresponding to respective magnets in the rotation control component; and
an operation determination module for determining a control operation of the rotation device according to the control position, wherein the control operation comprises a rotation operation.

The present disclosure also provides an electronic apparatus comprising: the above-described rotation control component;
a memory for storing computer program; and
a processor for implementing steps of the above-described rotation control method when executing the computer program.

The rotation control component provided by the present disclosure comprises a housing, a rotation device, a magnetic parameter detection device and a preset number of magnets, wherein a target surface of the housing is provided with a groove for accommodating the rotation device, wherein the rotation device provided in the groove at least partially protrudes from the target surface, and a rotating axis of the rotation device is parallel to the target surface, wherein the magnets are arranged at intervals in a circumference direction of the rotation device, and the magnetic parameter detection device is provided in the housing at a position corresponding to the rotation device, for detecting magnetic parameters corresponding to respective target rotating positions where the rotation device is rotated to, and wherein the target rotation positions are rotation positions of the magnets corresponding to the magnetic parameter detection device.

Thus, the present disclosure uses the magnetic parameter detection device to detect change in the magnetic parameters of the rotation device, which can detect the rotation positions corresponding to respective magnets in the rotation device, thereby achieving rotation detection of the rotation device. Therefore, users can control the electronic apparatus by rotating the rotation device, for adding a more stable and diverse human-computer interaction method to the electronic apparatus, providing users with more diverse functional operations, and improving the user experience. In addition, the present disclosure also provides a rotation control method, a rotation control device and an electronic apparatus, which also have the above beneficial effects.

### BRIEF DESCRIPTION OF DRAWINGS

In order to illustrate the technical solutions in the embodiments of the present disclosure or the prior art more clearly, the drawings required to be used in the content of the embodiments or the prior art will be introduced briefly as following. Obviously, the drawings in the following description are merely embodiments of the present disclosure, and for those of ordinary skill in the art, other drawings can also be obtained according to the provided drawings without any creative effort.

FIG. 1 is a structural diagram of a rotation control component provided by an embodiment of the present disclosure;

FIG. 2 is a top view of the rotation control component as shown in FIG. 1;

FIG. 3 is a schematic diagram of a rotation detection of the rotation device of the rotation control component as shown in FIG. 1;

FIG. 4 is a schematic diagram of a press detection of the rotation device of the rotation control component as shown in FIG. 1;

FIG. 5 is a schematic diagram of change in magnetic flux when the rotation device as shown in FIG. 4 is pressed;

FIG. 6 is a flowchart of a rotation control method provided by the embodiment of the present disclosure;

FIG. 7 is a schematic diagram of change in magnetic flux during a clockwise rotation of the rotation device of another rotation control method provided by the embodiment of the present disclosure;

FIG. 8 is a schematic diagram of a magnetic flux change during a counter-clockwise rotation of the rotation device of another rotation control method provided by the embodiment of the present disclosure; and

FIG. 9 is a structural block diagram of a rotation control device provided by the embodiment of the present disclosure.

### DETAILED DESCRIPTIONS

In order to make the purpose, technical solution, and advantages of the embodiments of the present disclosure clearer, the technical solution in the embodiments of the present disclosure will be described clearly and completely as following in combination with the drawings in the embodiments of the present disclosure. Obviously, the described embodiments are only a part of the embodiments of the present disclosure, but not all of the embodiments. Based on the embodiments of the present disclosure, all other embodiments obtained by those ordinary skilled in the art without creative labor fall within the protection scope of the present disclosure.

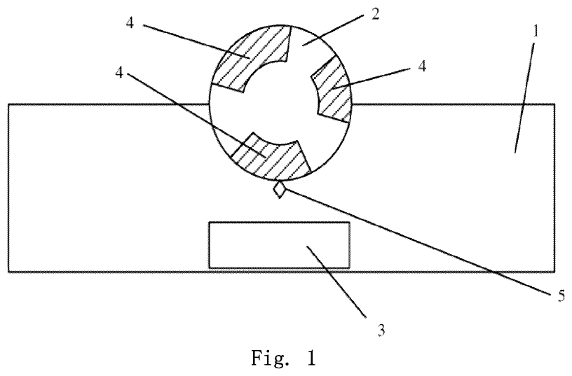

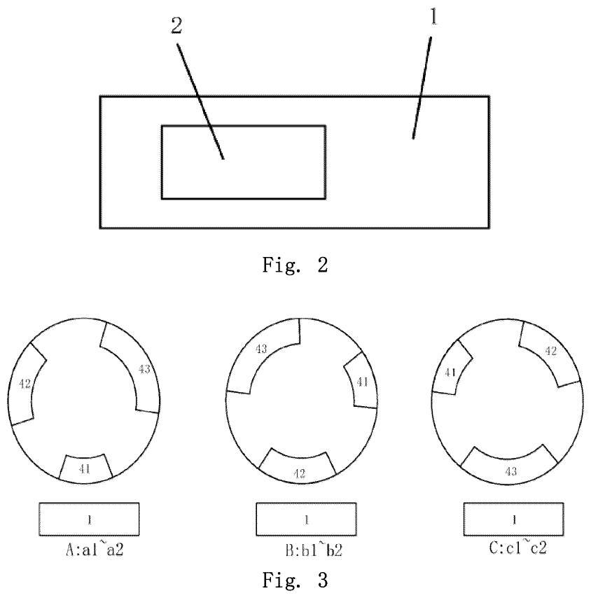

Please refer to FIGS. 1 and 2, and FIG. 1 is a structural diagram of a rotation control component provided by an embodiment of the present disclosure. The rotation control component may comprise a housing 1, a rotation device 2, a magnetic parameter detection device 3 and a preset number of magnets 4.

Among them, a target surface of the housing 1 is provided with a groove for accommodating the rotation device 2; the rotation device 2 provided in the groove at least partially protrudes from the target surface, and a rotation axis of the rotation device 2 is parallel to the target surface; the magnets 4 are arranged at intervals in a circumferential direction of the rotation device 2, and the magnetic parameter detection device 3 is provided in the housing 1 at a position corresponding to the rotation device 2, for detecting magnetic parameters corresponding to respective target rotation positions where the rotation device 2 is rotated to, and the target rotation positions are rotation positions of the magnets 4 corresponding to the magnetic parameter detection device.

It can be understood that the housing 1 in this embodiment may be a housing of electronic apparatuses such as wireless glasses, AR devices, VR devices and wireless headphones. The rotation device 2 in this embodiment may be installed at the groove in the target surface of the housing 1, and may rotate in clockwise or counter-clockwise direction according to a rotation action by the user to the part of the rotation device 2 protruding on the target surface. Among them, the target surface of housing 1 may be one outer surface of the groove provided in the housing 1 for accommodating the rotation device 2.

Correspondingly, the rotation device 2 in this embodiment may be a device installed at a groove in the target surface of the housing 1 and can rotate along a rotation axis. The specific device type of the rotation device 2 in this embodiment may be set by the designer himself according to the usage scene and the user requirement. For example, the rotation device 2 may be a cylindrical rotation disk as shown in FIG. 1, that is, the rotating axis of the rotation device 2 may be an axis of a circular cylinder. Or, the rotation device 2 may also be a polygonal cylinder, such as a regular dodecagonal cylinder. It is not limited in this embodiment.

Specifically, the magnetic parameter detection device 3 in this embodiment may be a device disposed inside the housing 1 for detecting magnetic parameters (such as magnetic flux and/or magnetic induction intensity), such as a magnetic flux detection device for detecting magnetic flux and a magnetic induction intensity detection device for detecting magnetic induction intensity. The specific device type and disposing position of the magnetic parameter detection device 3 in this embodiment may be set by the designer himself according to the usage scene and the user requirement. For example, the magnetic parameter detection device 3 may comprise a magnetic flux detection device such as a linear Hall sensor or other magnetic flux detection sensors. As shown in FIG. 1, when the magnetic parameter detection device 3 is a magnetic flux detection device, the magnetic flux detection device may be disposed at a position below the rotation device 2 in the housing 1, to detect the magnetic flux of the magnet 4 rotated to the below in the rotation device 2. As long as the magnetic parameter detection device 3 can detect the magnetic parameters of the rotation positions (that is, target rotation positions) corresponding to respective magnets 4 where the rotation device 2 is rotated to, to achieve the detection to the rotation position of the rotation device 2, it is not limited in this embodiment.

It should be noted that the preset number of magnets 4 in the rotation device 2 in this embodiment may be arranged at intervals in the circumferential direction along which the rotation device 2 is rotated, such that when the rotation device 2 is rotated to the rotation positions (that is, the target rotation positions) of the respective magnet 4 corresponding to the magnetic parameter detection device 3, the magnetic parameter detection device 3 may detect the corresponding magnetic parameters. The specific quantity of magnet 4 in this embodiment, that is, the specific value of the preset quantity, may be set by the designer himself according to practical scene and the user requirement, for example, the number of the magnet 4 (that is, the preset quantity) may be greater than or equal to 1, so as to determine whether the rotation device 2 rotates according to the magnetic parameters corresponding to the target rotation positions detected by the magnetic parameter detection device 3, to achieve the corresponding rotation action control, such as pause/start music playback when the rotation device 2 rotates. The number of the magnets 4 may also be greater than or equal to 3, so as to determine the rotation direction of the rotation device 2 (such as the clockwise rotation or the counter-clockwise rotation) according to the magnetic parameters corresponding to the target rotation positions detected by the magnetic parameter detection device 3, to achieve the corresponding rotation control. For example, the magnetic parameters corresponding to two adjacent target rotation positions detected by the magnetic parameter detection device are different, and magnetic parameters corresponding to two target rotation positions adjacent to the same target rotation position are different.

Correspondingly, the specific settings for the size and the arrangement position of the preset number of the magnets 4 in this embodiment can be set by the designer himself according to the practical scene and the user requirements. For example, the preset number of the magnets 4 may be specifically sector-ring shaped magnets arranged at intervals on a ring centered on the rotation axis in the rotation device 2 (such as sector-ring shaped magnets). Thus, the outside of the magnet 4 can be fitted with the outside of the rotation device, to improve the detection effect of the magnetic parameter detection device 3. That is, by configuring specific magnetic parameters such as the size and the material of the preset number of sector-ring shaped magnets, the changes of the magnetic parameters corresponding to the respective target rotation positions during the rotation process of the rotation device 2 can be achieved. For example, when the magnetic parameter detection device 3 is a magnetic flux detection device, the magnetic fluxes corresponding to the respective target rotating positions change during the rotating process of the rotation device 2, by configuring the size, the material and the magnetic induction intensity of the preset number of sector-ring shaped magnets.

Accordingly, in this embodiment, by configuring the specific magnet parameters of the preset number of sector-ring shaped magnets, the magnetic parameters corresponding to two adjacent target rotation positions detected by the magnetic parameter detection device 3 are different, and magnetic parameters corresponding to two target rotation positions adjacent to the same target rotation position are different. Thus, the magnetic parameters detected by the magnetic parameter detection device 3 can be used to determine the rotation direction of the rotation device 2 (such as clockwise rotation or counter-clockwise rotation), to achieve the corresponding rotation control, such as when the rotation device rotates a target rotation position in clockwise direction, the volume increases, and when the rotation device rotates a target rotation position in counter-clockwise direction, the volume decreases. For example, when the magnetic parameter detection device 3 is a magnetic flux detection device, the sizes of two adjacent sector-ring shaped magnets may be different and the sizes of two sector-ring shaped magnets adjacent to the same sector-ring shaped magnet may be different, such that the magnetic flux corresponding to the two adjacent target rotation positions detected by the magnetic parameter detection device 3 are different and the magnetic flux corresponding to the two target rotation positions adjacent to the same target rotation position are different, thereby the magnetic flux detected by the magnetic parameter detection device 3 can be used to determine the rotation direction of the rotation device 2 (such as clockwise rotation or counter-clockwise rotation), to achieve the corresponding rotation control. Further, the sizes of the preset number of sector-ring shaped magnets arranged at intervals on a ring centered on the rotation axis in the rotation device 2 may be different, such that the magnetic flux corresponding to the respective target rotation positions detected by the magnetic parameter detection device 3 are different. As shown in FIG. 1, the sizes of the three sector-ring shaped magnets in the rotation device 2 may be different, such that when the rotation device 2 is rotated to the rotation position (that is, the target rotation position) of each sector-ring shaped magnet closest to the magnetic parameter detection device 3, the magnetic parameter detection device 3 may detect the corresponding magnetic flux, to determine the target rotation position corresponding to the rotation device 2.

Specifically, when the magnetic parameter detection device 3 is a magnetic flux detection device, as shown in FIG. 3, when the rotation device 2 is rotated to a target rotation position corresponding to magnet 41 (that is, A state), that is, the rotation position of the sector-ring shaped magnet 41 nearest to the magnetic parameter detection device 3, the magnetic parameter detection device 3 can detect a magnetic flux scope in which the magnetic flux is in a range of a1˜a2. When the rotation device 2 is rotated to a target rotation position corresponding to a sector-ring shaped magnet 42 (that is, B state), the magnetic parameter detection device 3 can detect a magnetic flux scope in which the magnetic flux is in a range of b1˜b2. When the rotation device 2 is rotated to a target rotation position corresponding to a sector-ring shaped magnet 43 (that is, C state), the magnetic parameter detection device 3 may detect a magnetic flux scope in which the magnetic flux is a range of c1˜c2.

Correspondingly, when the magnetic parameter detection device 3 is a magnetic flux detection device, the preset number of magnets 4 arranged at intervals in the inner circumferential direction inside of the rotation device 2 may also have the same size, that is, the changes in the magnetic fluxes corresponding to the respective target rotation positions during the rotation process of the rotation device 2 can be achieved by setting the distance between the preset number of magnets 4 and the rotation axis (that is, the center of the circle). That is, adjacent magnets 4 may have different distances from the rotation axis and two magnets 4 adjacent to the same magnet 4 may have different distances from the rotation axis, such that the magnetic fluxes corresponding to the two adjacent target rotation positions detected by the magnetic parameter detection device 3 are different, and the magnetic fluxes corresponding to the two target rotation positions adjacent to the same target rotation position are different. As long as the preset number of magnets 4 in the rotation device 2 is set such that the magnetic fluxes corresponding to the two adjacent target rotation positions detected by the magnetic parameter detection device 3 are different, and the magnetic fluxes corresponding to two target rotation positions adjacent to the same target rotation position are different, it is not limited in this embodiment.

Further, in order to make the user to feel the respective target rotation positions during the process of rotating the rotation device 2, so as to accurately stop the rotation device 2 to the desired target rotation position, as shown in FIG. 1, the rotation control component in this embodiment may further comprise a limiting part 5 provided in the housing 1 for positioning the rotation of the rotation device 2 when the rotation device 2 is rotated to the respective target rotating positions, such that the user can accurately know the respective target rotation positions when the user feels a certain force limitation during the process of rotating the rotation device 2.

Specifically, this embodiment does not limit the specific device type of the limiting part 5, as shown in FIG. 1, specifically, the limiting part 5 may be a slot. Correspondingly, positioning slots or positioning holes corresponding to the respective target rotating positions may be disposed on a surface of the rotation device 2 opposite to the slot (such as the rotating surface as shown in FIG. 1), such that when the rotation device 2 rotates to the respective target rotating positions, projections on the slot are inserted into the corresponding positioning slots or positioning holes. Correspondingly, after the projection on the slot is inserted into the positioning slot or the positioning hole corresponding to the current target rotation position, the user can still rotate the rotation device 2 to move the projection on the slot away from the positioning slot or the positioning hole corresponding to the current target rotation position, such that the projection rotated to the slot is inserted into the positioning slot or the positioning hole corresponding to the next target rotation position. Specifically, the limiting part 5 may also be a micro switch. As long as the limiting part 5 is provided in the housing 1 such that the user can feel the respective target rotation positions when rotating the rotation device 2, it is not limited in this embodiment.

Further, in order to add control modes of the rotation control component and add diverse human-computer interaction modes to the electronic apparatus applying the rotation control component, the rotation control component provided by this embodiment may further comprise an elastic restoring assembly corresponding to the rotation device 2 provided in the housing 1, wherein, the rotation device can be pressed and disposed into the groove by the elastic reset assembly on the target surface of the housing 1. That is, the elastic restoring assembly may be used to move the rotation device 2 to the pressing position from its original position according to the pressing force of the rotation device 2 protruding from the target surface, and to return the rotation device 2 to its original position after the pressing force of the rotation device 2 protruding from the target surface has disappeared. In this embodiment, by providing the elastic restoring assembly, the user may press the rotation device 2 protruding from the target surface, such that the rotation device 2 moves downward, thus the relative distance between the rotation device 2 and the magnetic parameter detection device 3 changes, resulting in the change of the magnetic parameter detected by the magnetic parameter detection device 3. Correspondingly, after the user stops pressing the rotation device 2, the elastic restoring assembly may automatically return the rotation device 2 to the position before pressing.

Correspondingly, the magnetic parameter detection device 3 in this embodiment may also detect the magnetic parameters of the pressing positions corresponding to the respective target rotation positions of the rotation device 2. In other words, the magnetic parameter detection device 3 can not only detect the corresponding magnetic parameter change during the rotation process of the rotation device 2, to detect the magnetic parameters corresponding to the respective rotation positions, so as to determine the rotation position of the rotation device 2, but also detect the changes in the corresponding magnetic parameter during the process of pressing the rotation device 2, to detect the magnetic parameters of the pressing positions corresponding to the respective rotation positions, thereby determining the pressing position of the rotation device 2.

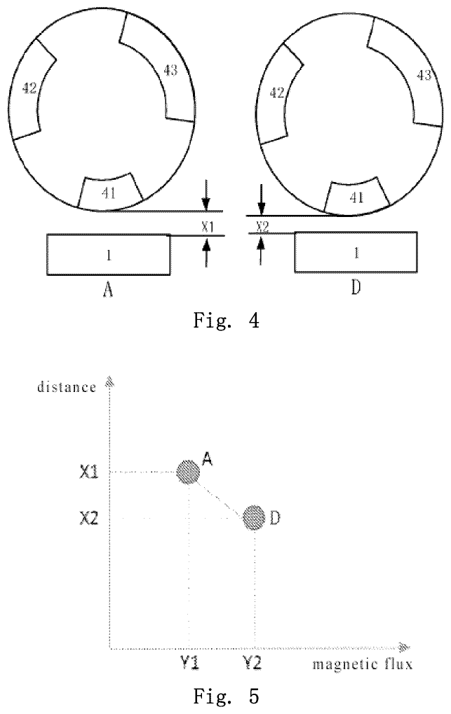

Specifically, as shown in FIGS. 1, 4 and 5, when the magnetic parameter detection device 3 is the magnetic flux detection device, before the user presses the rotation device 2, the distance between the rotation device 2 and the magnetic parameter detection device 3 is X1, and the magnetic flux detected by the magnetic parameter detection device 3 is Y1. After the user presses the rotation device 2, the distance between the rotation device 2 and the magnetic parameter detection device 3 is X2, and the magnetic flux detected by the magnetic parameter detection device 3 is Y2. Correspondingly, the electronic apparatus may determine that a pressing operation has been performed at the target rotation position of the magnet 41 after a Y1-Y2 change or a Y1-Y2-Y1 change in magnetic flux is detected by the magnetic parameter detection device 3.

In this embodiment, the magnetic parameter detection device 3 is used to detect the change of the magnetic flux of the rotation device 2, such that the rotating positions corresponding to respective magnets in the rotation device 2 can be detected, thus realizing the rotating detection of the rotation device 2. Thus, the user can control the electronic apparatus by rotating the rotation device 2, to achieve the switch of different functions of the electronic apparatus only by rotating the rotation device 2, thereby reducing the number of adjustment control components on the electronic apparatus, optimizing the spatial arrangement of the adjustment control components on the electronic apparatus, adding more stable and diverse human-computer interaction modes for the electronic apparatus, providing the users with more diverse functional operations, and improving the user experience.

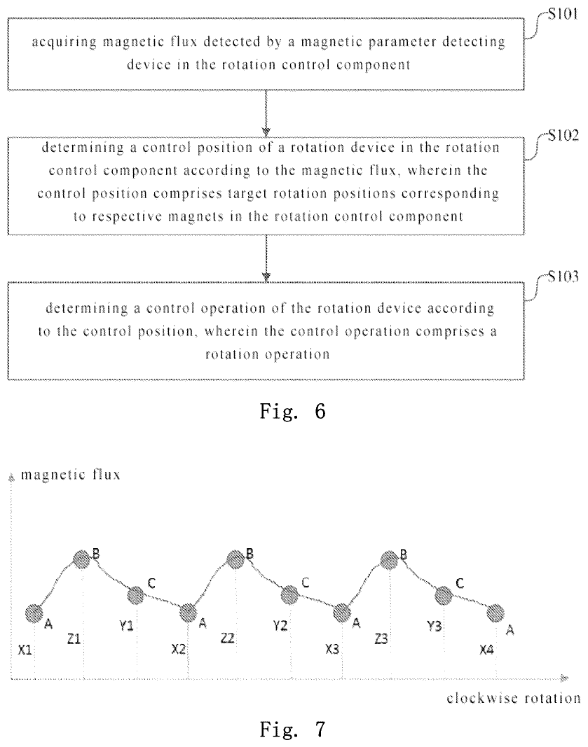

Please refer to FIG. 6, FIG. 6 is a flowchart of a rotation control method provided by the embodiment of the present disclosure. The rotation control method may be applied to the rotation control components provided by the above embodiments, comprising:

Step 101: acquiring magnetic parameters detected by a magnetic parameter detection device in the rotation control component.

It can be understood that the rotation control method provided by this embodiment can be applied to electronic apparatuses provided with the rotation control components of the above embodiment, such as wireless glasses, AR devices, VR devices, wireless headphones, etc. In this step, the processor of the electronic apparatus may obtain the magnetic parameters (such as magnetic flux and/or magnetic induction intensity, etc.) acquired by the magnetic parameter detection device in the rotation control component provided in the electronic apparatus, to determine the control operation of the rotation device (such as a rotating wheel) during the operation of the rotation control component using the acquired magnetic parameters, so as to perform the corresponding processing operation, and to add new human-computer interaction modes controlled by the rotation device. Step 102: determining a control position of a rotation device in the rotation control component according to the magnetic parameters, wherein the control position comprises target rotation positions corresponding to respective magnets in the rotation control component.

Specifically, the control position of the rotation device in this step may be a pre-set key position of the rotation device required to detect the control operation of the rotation device. The specific setting of the control position of the rotation device in this step may be set by the designer himself according to the practical scene and the user requirement. For example, when the control operation of the rotation device comprises an operation of a rotation action, the control position of the rotation device may comprise the respective target rotation positions corresponding to respective magnets in the rotation control component, to enable the processor to identify the operation of the rotation action of the rotation device (such as the occurrence of rotations and/or the number of rotations) according to the number of occurrence of the determined target rotation position. When the control operation of the rotation device comprises the rotation operation, the control position of the rotation device may comprise the respective target rotation positions corresponding to the respective magnets in the rotation control component, such that the processor can identify the rotation operation of the rotation device (such as a clockwise rotation operation and a counter-clockwise rotation operation) according to the change of the determined target rotation position. When the control operation of the rotation device comprises the rotation operation and the pressing operation, the control position of the rotation device can comprise not only the target rotation position, but also the pressing position, such as the pressing positions corresponding to respective target rotation positions, such that the processor can identify the pressing operation of the rotation device, such as a click operation, a double click operation and a long pressing operation, according to the change between the determined target rotation position and the pressing position. As long as the processor in the electronic apparatus can recognize the control operation of the rotation device used by the user according to the determined control position of the rotation device, it is not limited in this embodiment.

It should be noted that the specific manner for the processor to determine the control position of the rotation device in the rotation control component according to the magnetic parameters acquired by the magnetic parameter detection device in this step may be set by the designer himself according to the practical scene and the user requirements. For example, when the control operation of the rotation device comprises the rotation operation, if the magnetic parameters corresponding to the two adjacent target rotation positions are different and the magnetic parameters corresponding to the two target rotation positions adjacent to the same target rotation position are different, the processor may determine the current control position (that is, the current target rotation position) according to the current magnetic parameters, the previous target rotation position, and the range of the magnetic parameters corresponding to the two target rotation positions adjacent to the previous target rotation position, wherein the current magnetic parameter is any one of the magnetic parameters, the current control position is any one target rotation position of the two target rotation positions adjacent to the previous target rotation position, and the magnetic parameter ranges corresponding to the two target rotation positions adjacent to the previous target rotation position are not overlapped. That is, when the control operation of the rotation device only comprises the rotation operation, in the case where the currently obtained magnetic parameter is in any one magnetic parameter range of the two magnetic parameter ranges corresponding to the two target rotation positions adjacent to the newly determined target rotation position (that is, the previous target rotation position), the processor may determine the target rotation position corresponding to the magnetic parameter range as the newly determined target rotation position (that is, the current target rotation position). For example, when the magnetic parameter detection device is a magnetic flux detection device that acquires the magnetic flux, if the magnetic fluxes corresponding to the two adjacent target rotation positions are different and the magnetic fluxes corresponding to two target rotation positions adjacent the same target rotation position are different, the processor may determine the current control position (that is, the current target rotation position) according to the current magnetic flux, the previous target rotation position, and the magnetic flux ranges corresponding to the two target rotation positions adjacent to the previous target rotation position. For example, when the control operation of the rotation device comprises the rotation operation, if the magnetic fluxes corresponding to the respective rotation positions are different, the processor may also determine the current control position according to the current magnetic flux and the magnetic flux ranges corresponding to respective target rotation positions. Wherein, the current magnetic flux is any one of the magnetic flux, the current control position is any one of the target rotation positions, and the magnetic flux ranges are not overlapped. When the control operation of the rotation device comprises the rotation operation, in the case where the magnetic parameter change corresponding to the magnetic parameter rotation change graph is detected, the processor may also determine that the current control position is the target rotation position corresponding to the rotation end point of the magnetic parameter rotation change graph corresponding to the magnetic parameter change, according to the magnetic parameter rotation change curve corresponding to the adjacent two target rotation positions stored in advance.

Further, when the rotation control component comprises the elastic restoring assembly corresponding to the rotation device, that is, when the control operation of the rotation device comprises the rotation operation and the pressing operation, the processor may determine the control position according to the magnetic parameters (such as magnetic flux) within the first preset period. If the magnetic parameter range corresponding to the respective target rotation positions and the magnetic parameter range of the pressing positions corresponding to the respective rotation positions are stored in advance, the processor may determine all the control positions in the first preset period according to the detected magnetic parameters in the first preset period. Among them, the magnetic parameter ranges corresponding to the respective target rotation positions are not overlapped. For example, when the magnetic parameter detection device is the magnetic flux detection device, the processor may determine all the control positions in the first preset period according to the magnetic flux detected in the first preset period. Among them, the magnetic flux ranges corresponding to the respective target rotation positions are not overlapped. When the magnetic parameter rotation change curve corresponding to the two adjacent target rotation positions and the magnetic parameter pressing change curve corresponding to the respective target rotation positions are stored in advance, when it is detected that the magnetic parameter changes in the first preset period conform to the magnetic parameter pressing change curve, the processor may determine the pressing position corresponding to the magnetic parameter pressing change curve satisfied by the current control position.

Step 103: determining a control operation of the rotation device according to the control position, wherein the control operation comprises a rotation operation.

It can be understood that in this step, the processor may identify the control operation of the user to the rotation device according to the determined control position of the rotation device. The specific settings of the control operation of the rotation device in this step can be set by the designer himself according to the practical scene and the user requirements. For example, the control operation of the rotation device may comprise the operation of the rotation action of the rotation device, such as the occurrence of the rotation operation and the one circle rotation operation. The control operation of the rotation device may comprise the rotation operation of the rotation device, such as the clockwise rotation operation and the counter-clockwise rotation operation. The control operation of the rotation device may also comprise the pressing operation of the rotation device, such as the click operation, the long pressing operation and the double click operation.

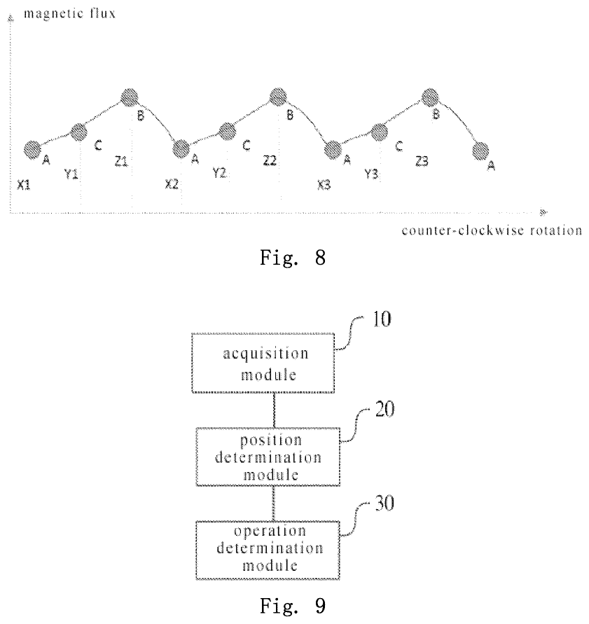

Specifically, in this step, the specific methods for determining the control operation of the rotation device according to the control position by the processor can be set by the designer himself. For example, the processor determines the control operation according to the control position within the second preset period. Among them, the control operation comprises the rotation operation or the rotation operation and the pressing operation. The rotation operation comprises a clockwise rotation operation and/or a counter-clockwise rotation operation, and the pressing operation comprises a one-click operation and/or a long pressing operation. In other words, the processor may identify the control operation of the rotation device according to the change in the control position in the second preset period. As shown in FIGS. 1, 3 and 7, the target rotation positions corresponding to the three magnets in the rotation device may be the positions of the A state, the B state and the C state. When it is detected that only a control position change of A-B-C-A, B-C-A-B or C-A-B-C occurs during the second preset period, the processor can determine that the control operation of the rotation device is a clockwise rotation operation, that is, the clockwise rotation operation may comprise a clockwise one circle rotation operation. When it is detected that only a control position change of A-B-C, B-C-A or C-A-B occurs during the second preset period, the processor can determine that the control operation of the rotation device is the clockwise rotation operation. When it is detected that only a control position change of A-B, B-C or C-A occurs during the second preset period, the processor can determine that the control operation of the rotation device is an operation of clockwise rotating by one position, that is, the clockwise rotation operation may comprise an operation of clockwise rotating by one position. Correspondingly, the clockwise rotation operation may also comprise an operation of clockwise rotating by two positions. As shown in FIGS. 1, 3 and 8, when it is detected that only a control position change of A-C-B-A, B-A-C-B or C-B-A-C occurs during the second preset period, the processor can determine that the control operation of the rotation device is an operation of counter-clockwise rotating, that is, the counter-clockwise rotation operation may comprise an operation of counter-clockwise rotating by one circle. Correspondingly, the counter-clockwise rotation operation may also comprise an operation of counter-clockwise rotating by one position and/or an operation of counter-clockwise rotating by two positions.

Correspondingly, as shown in FIGS. 1, 4 and 5, when it is detected that only the control position change from the target rotation position corresponding to the magnet 41 (the state A) to the pressing position corresponding to the magnet 41 (the state D) occurs during the second preset period, the processor can determine that the control operation of the rotation device is a pressing operation. It is also can be, when it is detected that only the control position change of A-D-A occurs during the second preset period, the processor determines that the control operation of the rotation device is an pressing operation. When the pressing operation comprises the click operation and the double click operation, and when it is detected that only the control position change of A-D-A occurs during the second preset period, the processor can determine that the control operation of the rotation device is a click operation. When it is detected that only the control position change of A-D-A-D-A occurs during the second preset period, the processor detects that the control operation of the rotation device is a double-click operation. As long as the processor can determine the control position and identify the control operation of the rotation device, it is not limited in this embodiment.

It should be noted that, in the present embodiment, this step may also be followed by a step for executing a corresponding control command according to the determined control operation. In other words, the processor of the electronic apparatus may execute the corresponding control command after identifying the control operation of the rotation device according to the control command corresponding to the predetermined respective control operations. For example, when the electronic apparatus is a wireless headphone, the clockwise rotation operation and the counter-clockwise rotation operation may respectively correspond to a command of increasing the volume and a command of reducing the volume, so that the user may control the volume of the wireless headphone by rotating the rotation device. The pressing operation may correspond to the pause/start command, so that the user may control the pause and the start of playback content of the wireless headphone by pressing the rotation device.

In the present embodiment, by determining the control position of the rotation device in the rotation control component according to the magnetic parameters, the magnetic parameter change of the rotation device can be detected according to the magnetic parameter detection device, and the rotating positions corresponding to the respective magnets in the rotation device can be detected. Moreover, by determining the control operation of the rotation device according to the control position, the rotation detection of the rotation device is achieved, so that the user may control the electronic apparatus by rotating the rotation device, thereby adding more stable and diverse human-computer modes to the electronic apparatus, providing users with more diverse functional operations and improving user experience.

Please refer to FIG. 9, FIG. 9 is a structural block diagram of a rotation control device provided by the embodiment of the present disclosure. The rotation control device may be applied to the rotation control component in the above embodiments, comprising:
an acquisition module 10 for acquiring magnetic parameters detected by a magnetic parameter detection device in the rotation control component;
a position determination module 20 for determining a control position of the rotation device in the rotation control component according to the magnetic parameters, wherein the control position comprises target rotation positions corresponding to respective magnets in the rotation control component; and
an operation determination module 30 for determining a control operation of the rotation device according to the control position, wherein the control operation comprises a rotation operation.

Optionally, the position determination module 20 may be specifically used to determine the current control position according to the current magnetic parameter and the magnetic parameter ranges corresponding to the respective rotation positions. Among them, the current magnetic parameter is any one of the magnetic parameters, the current control position is any one of the target rotation positions, and the respective magnetic parameter ranges are not overlapped.

Optionally, when the rotation control component comprises the elastic restoring assembly corresponding to the rotation device, the position determination module 20 may be specifically used to determine the control position according to the magnetic parameters within the first preset period. wherein, the control position comprises the target rotation position and the pressing position.

Optionally, the operation determination module 30 may be specifically used to determine the control operation according to the control positions within the second preset period. Among them, the control operation comprises the rotation operation, or the rotation operation and the pressing operation, the rotation operation comprises a clockwise rotation operation and/or a counter-clockwise rotation operation, and the pressing operation comprises a one-click operation and/or a long-pressing operation.

In the present embodiment, the control position of the rotation device in the rotation control component is determined by the position determination module 20 according to the magnetic parameters, such that the magnetic parameter change of the rotation device can be detected according to the magnetic parameter detection device, and the rotating positions corresponding to respective magnets in the rotation device can be detected. In addition, the control operation of the rotation device is determined by the operation determination module 30 according to the control position to achieve the rotation detection of the rotation device, so that the user can control the electronic apparatus by rotating the rotation device, thereby adding more stable and diverse human-computer interaction modes to electronic apparatus, and providing users with more diverse functional operations and improving user experience.

The embodiment of the present disclosure also provides an electronic apparatus comprising the rotation control component provided in the above embodiment; a memory for storing computer programs; a processor for implementing the steps of the rotation control method provided by the above embodiments when executing the computer program.

In addition, the embodiment of the present disclosure also provides a computer-readable storage medium on which a computer program is stored, and when the computer program is executed by the processor, the steps for implementing the rotation control method provided by the above embodiments are achieved. The computer storage media may comprise media such as a U disk, a mobile hard disk, a Read-Only Memory (ROM), a Random Access Memory (RAM), a diskette or an optical disc which can store program code.

The various embodiments in the present disclosure are described in a progressive manner, and each embodiment focuses on the differences from other embodiments. The same or similar parts between each embodiment may be referred to each other. As for the device, the electronic apparatus and a computer-readable storage medium disclosed in the embodiment, the description is relatively simple since it corresponds to the method disclosed in the embodiment. The relevant information may refer to the description for method.

A rotation control component, a rotation control component method, a rotation control component device and an electronic apparatus provided by the present disclosure are described in detail. The present disclosure applies specific examples are used to explain the principle and embodiments of the present disclosure. The explanation to the above embodiments is only used to help understanding the method of the present disclosure and the core ideas thereof. It should be pointed out that for those ordinary skilled in the art, without deviating from the principle of the present disclosure, several improvements and modifications may also be made to the present disclosure, and these improvements and modifications also fall within the protection scope of the claims of the present disclosure.

1. A rotation control component comprising: a housing, a rotation device, a magnetic parameter detection device and a preset number of magnets,
wherein a target surface of the housing is provided with a groove for accommodating the rotation device,
wherein the rotation device provided in the groove at least partially protrudes from the target surface, and a rotating axis of the rotation device is parallel to the target surface,
wherein the magnets are arranged at intervals in a circumference direction of the rotation device, and the magnetic parameter detection device is provided in the housing at a position corresponding to the rotation device, for detecting magnetic parameters corresponding to respective target rotating positions where the rotation device is rotated to, and
wherein the target rotation positions are rotation positions of the magnets corresponding to the magnetic parameter detection device.

2. The rotation control component according to claim 1, wherein the preset number is greater than or equal to 3, and magnetic parameters corresponding to two adjacent target rotation positions detected by the magnetic parameter detection device are different, and magnetic parameters corresponding to two target rotation positions adjacent to the same target rotation position are different.

3. The rotation control component according to claim 1, further comprising:
a limiting part provided in the housing, for positioning a rotation of the rotation device when the rotation device is rotated to the respective target rotating positions.

4. The rotation control component according to claim 1, further comprising:
an elastic restoring assembly corresponding to the rotation device provided in the housing,
wherein the rotation device can be pressed and disposed into the groove by the elastic restoring assembly.

5. A rotation control method applied to the rotation control component according to claim 1, comprising steps:
acquiring magnetic parameters detected by a magnetic parameter detection device in the rotation control component;
determining a control position of a rotation device in the rotation control component according to the magnetic parameters, wherein the control position comprises target rotation positions corresponding to respective magnets in the rotation control component; and
determining a control operation of the rotation device according to the control position,
wherein the control operation comprises a rotation operation.

6. The rotation control method according to claim 5, wherein the step of determining a control position of a rotation device in the rotation control component according to the magnetic parameters comprises:
determining a current control position according to a current magnetic parameter and magnetic parameter ranges corresponding to respective target rotating positions,
wherein the current magnetic parameter is any one of the magnetic parameters, the current control position is any one of the target rotation positions, and the respective magnetic parameter ranges are not overlapped.

7. The rotation control method according to claim 5, wherein when the rotation control component comprises an elastic restoring assembly corresponding to the rotation device, the step of determining a control position of a rotation device in the rotation control component according to the magnetic parameters comprises:
determining the control position according to the magnetic parameters in a first preset period,
wherein the control position comprises the target rotation positions and a pressing position.

8. The rotation control method according to claim 5,
wherein the step of determining a control operation of the rotation device according to the control position comprises:
determining the control operation according to the control position in a second preset period,
wherein the control operation comprises the rotation operation, or the rotation operation and a pressing operation, and
wherein the rotation operation comprises a clockwise rotation operation and/or a counter-clockwise rotation operation, and the pressing operation comprises a click operation and/or a long pressing operation.

9. A rotation control device applied to the rotation control component of claim 1, comprising:
an acquisition module for acquiring magnetic parameters detected by a magnetic parameter detection device in the rotation control component;
a position determination module for determining a control position of a rotation device in the rotation control component according to the magnetic parameters, wherein the control position comprises target rotation positions corresponding to respective magnets in the rotation control component; and
an operation determination module for determining a control operation of the rotation device according to the control position,
wherein the control operation comprises a rotation operation.

10. An electronic apparatus comprising:
the rotation control component according to claim 1;
a memory for storing computer program; and
a processor for implementing steps of the rotation control method according to claim 5 when executing the computer program.
